(19) United States
(12) Patent Application Publication
(10) Pub. No.: US 2026/0075142 A1
(43) Pub. Date: Mar. 12, 2026

(54) SYSTEM AND METHOD FOR TRACKING AND ANALYZING SIGNALS ASSOCIATED WITH METRICS AND PROVIDING ACTIONABLE INSIGHTS

(71) Applicant: Genesys Cloud Services, Inc., Menlo Park, CA (US)

(72) Inventors: Bayu Wicaksono, Menlo Park, CA (US); Wei Xun Ter, Menlo Park, CA (US); Satya Katragadda, Menlo Park, CA (US); Ameen Oladehinde-Bello, North York (CA); Travis Humphreys, Menlo Park, CA (US); Olivier Jouve, Menlo Park, CA (US)

(21) Appl. No.: 18/934,150

(22) Filed: Oct. 31, 2024

Related U.S. Application Data
(60) Provisional application No. 63/693,965, filed on Sep. 12, 2024.

(51) Int. Cl. H04M 3/51; G06F 40/40; H04L 51/02; H04M 3/523

(52) U.S. Cl. CPC H04M 3/5175; G06F 40/40; H04L 51/02; H04M 3/5191; H04M 3/5238; H04M 2201/42; H04M 2203/402

(57) ABSTRACT

A method for tracking and analyzing signals associated with metrics and providing actionable insights according to an embodiment includes receiving metric data, including workload metric data, for a contact center during a predefined time interval, analyzing the metric data to generate analysis data, wherein the metric data is analyzed separately for each agent planning group, processing the analysis data using at least one large language model to generate a set of insights associated with the metric data of the contact center and at least one possible action to improve a condition associated with the set of insights, displaying the metric data, the set of insights, and an indicator of the at least one possible action on a graphical user interface accessible to a user, and automatically executing a possible action in response to the user's selection of the possible action via the graphical user interface.

### CROSS-REFERENCE TO RELATED APPLICATIONS

This application claims priority to and the benefit of U.S. Provisional Application No. 63/693,965, titled “System and Method for Tracking and Analyzing Signals Associated with Metrics and Providing Actionable Insights,” filed on Sep. 12, 2024, the contents of which are incorporated herein by reference in their entirety.

### BACKGROUND

Contact centers rely on a very large number of agents to communicate with and respond to client inquiries. Some of the more important decisions associated with contact center operations relate to staffing, such as workload balancing, forecasting agent demand, scheduling agents, and related considerations. For example, contact centers attempt to schedule to right number of employees with the right skills at the right time to handle the interaction workload and meet the relevant quality standards. However, when managing a contact center, there may be many thousands of calls per hour, and therefore, the administrator or supervisor typically has limited visibility into what is actually happening within the contact center. For example, it is difficult to see certain signals that may ultimately turn into something problematic within the next few hours, so the administrator is not prepared to address such challenges when they arise.

### SUMMARY

One embodiment is directed to a unique system, components, and methods for tracking and analyzing signals associated with metrics and providing actionable insights. Other embodiments are directed to apparatuses, systems, devices, hardware, methods, and combinations thereof for tracking and analyzing signals associated with metrics and providing actionable insights.

According to an embodiment, a method for tracking and analyzing signals associated with metrics and providing actionable insights may include receiving, by a computing system, metric data for a plurality of metrics of a contact center during a predefined time interval, wherein the plurality of metrics comprises at least one workload metric related to a workload of the contact center, analyzing, by an analytics engine of the computing system, the metric data to generate analysis data, wherein the metric data is analyzed separately for each agent planning group of a plurality of agent planning groups, processing, by a large language model engine of the computing system, the analysis data using at least one large language model to generate a set of insights associated with the metric data of the contact center and at least one possible action to improve a condition associated with the set of insights, displaying, by the computing system, the metric data, the set of insights, and an indicator of the at least one possible action on a graphical user interface accessible to a user, and automatically executing, by the computing system, the at least one possible action in response to the user's selection of the at least one possible action via the graphical user interface.

In some embodiments, the at least one workload metric may include a call volume of the contact center during the predefined time interval.

In some embodiments, the at least one workload metric may include an average handle time of the contact center during the predefined time interval.

In some embodiments, the at least one workload metric may include a number of scheduled agents of the contact center during the predefined time interval.

In some embodiments, analyzing the metric data to generate the analysis data may include performing at least one of outlier detection analysis, time series analysis, or correlation analysis on the metric data.

In some embodiments, the plurality of metrics may further include a topic metric related to trending topics of the contact center.

In some embodiments, the plurality of metrics may further include a user sentiment metric related to an overall sentiment of users of the contact center.

In some embodiments, the method may further include providing, by the computing system, a chatbot via the graphical user interface, wherein the chatbot is configured with at least one of an agent persona or a supervisor persona.

In some embodiments, the at least one possible action may include updating an agent schedule of the contact center to improve the condition.

In some embodiments, processing the analysis data using the at least one large language model to generate the set of insights may include processing the analysis data using a hierarchy of large language models.

In some embodiments, each large language model in the hierarchy of large language models may be configured with a distinct custom prompt.

In some embodiments, the hierarchy of large language models may include a consolidated large language model that is configured to generate a summary of the analysis data and the set of insights.

In some embodiments, the set of insights may include a diagnosis section that describes a current state of the contact center, a prognosis section that describes a predicted future state of the contact center, and a prescription section that describes a corrective action associated with at least one of the current state of the contact center or the predicted further state of the contact center.

According to another embodiment, a computing system for tracking and analyzing signals associated with metrics and providing actionable insights may include at least one processor and at least one memory comprising a plurality of instructions stored thereon that, in response to execution by the at least one processor, causes the computing system to receive metric data for a plurality of metrics of a contact center during a predefined time interval, wherein the plurality of metrics comprises at least one workload metric related to a workload of the contact center, analyze the metric data to generate analysis data, wherein the metric data is analyzed separately for each agent planning group of a plurality of agent planning groups, process the analysis data using at least one large language model to generate a set of insights associated with the metric data of the contact center and at least one possible action to improve a condition associated with the set of insights, display the metric data, the set of insights, and an indicator of the at least one possible action on a graphical user interface accessible to a user, and automatically execute the at least one possible action in response to the user's selection of the at least one possible action via the graphical user interface.

In some embodiments, the at least one workload metric may include a call volume of the contact center during the predefined time interval, an average handle time of the contact center during the predefined time interval, and a number of scheduled agents of the contact center during the predefined time interval.

In some embodiments, to analyze the metric data to generate the analysis data may include to perform at least one of outlier detection analysis, time series analysis, or correlation analysis on the metric data.

In some embodiments, the plurality of metrics may further include a topic metric related to trending topics of the contact center, and a user sentiment metric related to an overall sentiment of users of the contact center.

In some embodiments, the plurality of instructions may further cause the computing system to provide a chatbot via the graphical user interface, wherein the chatbot is configured with at least one of an agent persona or a supervisor persona.

In some embodiments, the at least one possible action may include updating an agent schedule of the contact center to improve the condition.

In some embodiments, to process the analysis data using the at least one large language model to generate the set of insights may include to process the analysis data using a hierarchy of large language models, each large language model in the hierarchy of large language models may be configured with a distinct custom prompt, the hierarchy of large language models may include a consolidated large language model that is configured to generate a summary of the analysis data and the set of insights, and the set of insights may include a diagnosis section that describes a current state of the contact center, a prognosis section that describes a predicted future state of the contact center, and a prescription section that describes a corrective action associated with at least one of the current state of the contact center or the predicted further state of the contact center.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIG. 3 is a simplified block diagram of at least one embodiment of a high level architecture and system flow for tracking and analyzing signals associated with metrics and providing actionable insights; and

FIG. 4 is a simplified graphical user interface for displaying signal data and actionable insights and providing for co-pilot interaction.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

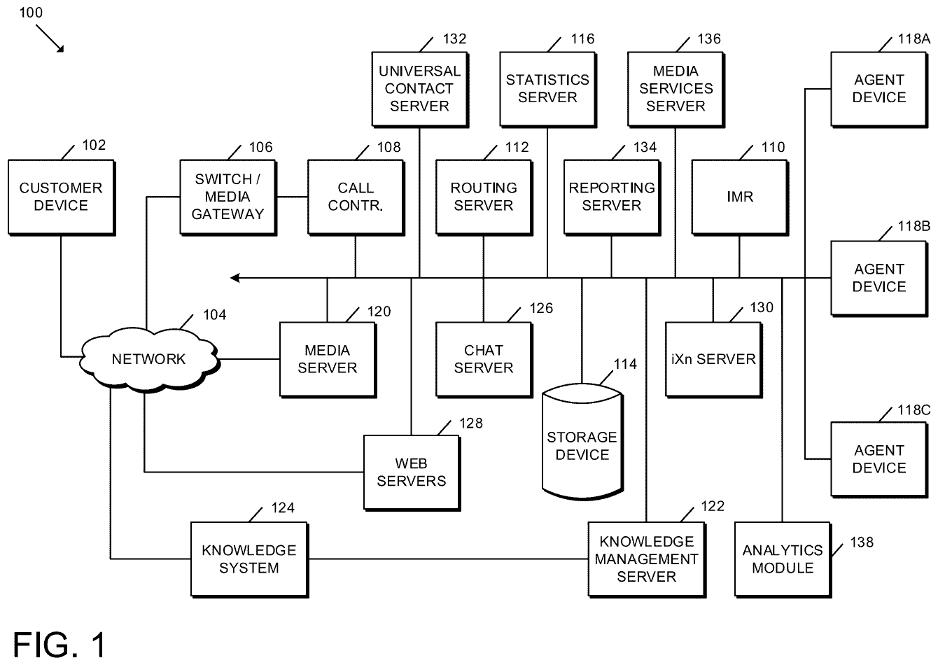

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually. Other actions could include improving the efficiency of the contact centers to reduce the handle time of the customers by optimizing schedules such that the staff with right skills are available at the appropriate times to handle specific customer conversations. This may be achieved through optimizing the schedules across the whole organization. Similarly, staff can be shuffled to answer high volume conversations from low volume conversations or moving activities like training to accommodate sudden increase in contact center volume.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

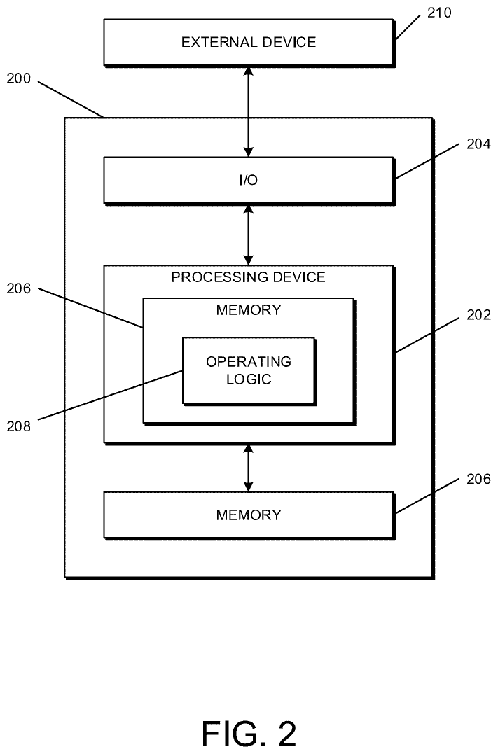

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls.

The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc.

Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, contact center data (e.g., data about actual and forecasted call volumes, handle times, and performance metrics of the contact center) and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers. The analytics module may also generate recommendations to improve the operational performance of the contact center based on the real-time signals ingested into the contact center from various sources.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

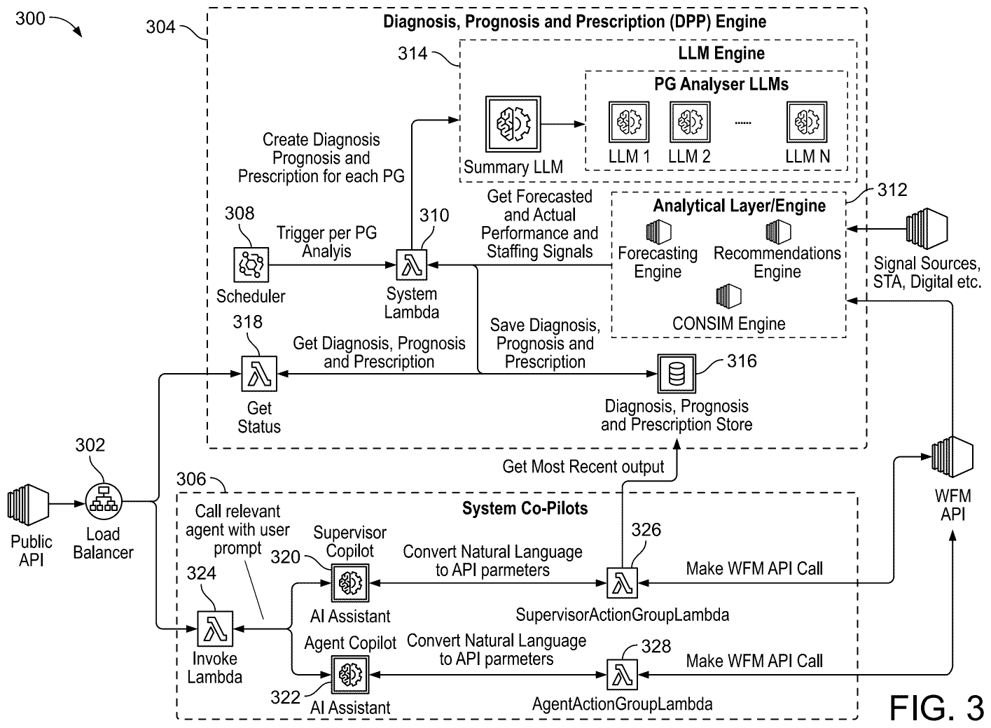

Referring now to FIG. 3, a high level architecture and system flow of a system 300 for tracking and analyzing signals associated with metrics and providing actionable insights. It should be appreciated that the system 300 provides diagnostic prognosis, actionable insights, and prescriptive solutions to contact center related problematic systems and/or systemic issues within the contact center. Further, as described herein, the system 300 also helps to orchestrate the execution of a prescribed solution that is selected by a user (e.g., an agent or a supervisor).

In the illustrative embodiment, it should be appreciated that the analyzed metrics are those can be causally correlated in order for the WFM planner to provide validation of the insights provided by the artificial intelligence system.

As described in greater detail below, the system 300 may continuously monitor key performance indicators (KPIs) and various signals, flag significant deviations from expected patterns, identify relationships, correlations, and causality between signals, and/or identify and address potential issues early. The system 300 may identify causal relationships between unusual patterns with specific KPIs, assess the broader impact on the contact center through forecasting, determine root causes by analyzing signals and staffing, correlate diagnosed problems with expected staffing, identify future staffing gaps, assess the impact of unfilled staffing gaps, propose actionable strategies (e.g., by leveraging machine learning and/or simulation), prioritize prospective solutions by impact and/or feasibility, target improvements within a particular timeframe, automate execution of selected solutions, and/or otherwise monitor, diagnose, prognose, and/or prescribe.

The load balancer 302 may function as the main entry point of the system 300, by balancing the load for two application programming interfaces (APIs). In particular, one API may be accessed to allow users to get system status information from the diagnosis, prognosis, and prescription (DPP) engine 304 and another API may be used to allow users to converse with the system co-pilots 306. It should be appreciated that each of the co-pilots 306 may be embodied as a chatbot or other type of automated agent. It should be further appreciated that the chatbot has context of the detailed insights from the system, which allows it to respond with relevant answers.

It should be appreciated that the DPP engine 304 may function to diagnose issues in the call center, providing a prognosis (e.g., forecasting the potential improvement or degradation of the performance) and prescribing a solution for the detected issue. The scheduler 308 may trigger the analysis by the DPP engine 304 based on a preconfigured interval (e.g., every 15 minutes, every 30 minutes, every hour, etc.). That is, in some embodiments, the DPP engine 304 may reforecast the data described herein every preconfigured interval (e.g., every 15 minutes, every 30 minutes, every hour, etc.). The analysis may be for each agent planning group in a business unit, a management unit, or any predefined entity or grouping in the contact center organizational chart, and may include identifying any issues, forecasting how those issues will progress over time, and providing actionable solutions to those issues (which may be selectable by a user). The system lambda 310 may serve as the main orchestrator of the DPP engine 304 flow. The system lambda 310 may pull data from the analytics engine 312 and, using this data, call the LLM engine 314 to produce the diagnosis, prognosis, and prescriptive solutions in natural language format. The output from the LLM engine 314 may be saved to a database table 316 to allow for quicker data access when the data is requested via the user interface. At every preconfigured interval, as described above, the output of the LLM engine 314 is saved to the database 316. When the user interface displays the status, the get status lambda 318 reads the saved data in the table 316 and serves the retrieved data to the user interface. It should be appreciated that the database table 316 may be embodied as any type of table, database, and/or other data structure for performing the functions described herein.

It should be appreciated that the analytics engine 312 is responsible for analyzing performance signals and providing those signals along with analytical and/or mathematical summaries of the signals to the system lambda 310. In the illustrative embodiment, each of the analyses is performed on a finer level of granularity, for example, a planning group level, such that there is a separate analyses for each planning group. In various embodiments, the analytics engine 312 may retrieve data from the WFM system and perform outlier detection analysis, time series analysis, correlation analysis, and/or execute one or more other analytics on the WFM data (e.g., the signal data described herein). In some embodiments, the analytics engine 312 outputs the results of the analyses in a predefined format (e.g., a JavaScript Object Notation (JSON) format) for consumption by the LLM engine 314. The LLM engine 314 provides natural language summaries of the numerical analyses performed on the contact center data at the planning group level. In some embodiments, each planning group may be analyzed by an individual LLM of the LLM engine 314 based on the data received by the analytics engine 312 and saved to the database. In such embodiments, if the WFM planner or Intraday manager selects multiple PGs or groupings to evaluate, the analysis of each planning group may be passed to a summary LLM that extracts individual summaries from the database and generates a concise summary of the selected planning groups highlighting those that are performing as expected, and those that are not, their diagnosis, prognosis, and prescription and recommendations on how to improve the performance of the planning groups. In other words, in some embodiments, the LLM engine 314 may include a master LLM that ingests the outputs for each of the planning groups and verbalizes or summarizes the findings in a natural language format. In some embodiments, the analytics engine 312 may analyze workload metric data, topic metric data, social media trend data, and/or related data/signals and output analysis data associated with workload insights, topic insights, social media insights, and/or other insights separately, which may be further processed by the LLM engine 314 to provide natural language summaries or variations thereof to the user.

It should be appreciated that the analytics engine 312 is not only able to perform anomaly detection and re-forecasting if an anomaly is detected, but the analytics engine 312 may also provide specific recommendations as to how to alleviate these problems, which allows for consistency in what is provided to the LLM engine 314. As such, in the illustrative embodiment, the LLM may be restricted to interpreting the JSON input (or data in another predefined format) that is provided. This also enables a history of what recommendations have been provided and the reasons for those recommendations, which is important when a user asks why the LLM is recommending a particular action. Additionally, in various embodiments, a multi-agent setup may be leveraged in which multiple agents are analyzing the signals (e.g., one agent per signal) rather than relying on a single agent to perform the analysis. For example, one agent may analyze call volume and another agent may analyze service level. These agents may then generate their analyses and provide them to a master agent that combines all of the analyses and provides a summary/aggregation to the end user. This helps with fine-tuning the LLM, scalability, and choosing which model to be used (e.g., rather than relying exclusively on one large model).

It should be further appreciated that the analytics engine 312 may detect and categorize various anomalies in the data. For example, for average handle time, if the data actuals are higher than the forecasted average handle time, then this data divergence could be deemed an anomaly. In another example, using call volume, if the actual call volume is beyond the upper bound or lower bound of the forecast, then the data divergence could be categorized as an anomaly (e.g., based on the average handle time and the call volume), and the staffing requirements could be generated from this.

The system co-pilots engine 306 allows for users to converse with artificial intelligence (AI) systems (e.g., the AI assistant 320, 322) that leverage LLMs by leveraging various personas (e.g., an agent persona, workforce management (WFM) persona, and/or other personas) depending on the particular context or graphical user interface. The system co-pilots engine 306 may further carry out tasks (e.g., automatically) based on user input or interaction with the respective AI assistant 320, 322. The invoke lambda 324 may serve as the entry point to the system co-pilots engine 306. The invoke lambda 324 may create a chat session and, using an agent parameter, route a user question to the correct co-pilot (e.g., supervisor or agent co-pilot). In the illustrative embodiment, a separate AI assistant 320, 322 (e.g., AWS Bedrock Agent) may be created for each co-pilot persona, each with its own sets of capabilities and its own prompts. Both co-pilots are capable of converting user natural language requests to API request parameters that are passed to respective action group lambdas 326, 328. A mapping is provided to the agent that specifies what parameters are required for each potential request made by the user. For example, a WFM planner may ask to see what agents are scheduled to start their shift at 1pm on a particular day. The corresponding API calls are determined by the respective action group lambda 326, 328 (e.g., based on the user request and respective API mapping), which executes the API call and returns the data back to the respective AI assistant 320, 322. The data can then be translated to natural language and returned to the user. It should be appreciated that the action group lambdas 326, 328 are sent parameter and API data and are responsible for actually executing the API calls to the relevant WFM APIs.

It should be appreciated that the system 300 may leverage LLM prompt engineering for the various LLMs in the LLM engine 314 to perform the functions described herein. It should be appreciated that an LLM prompt may be in three parts: the setup, the context, and the output. The setup provides information on what the LLM should do (e.g., “You are a bot, and you are supposed to provide a real time overview of the contact center and also additional information of a high level overview of what it needs to do.”). Clarity can also be provided to the LLM to help prevent hallucination and increase confidence of the agent. For example, the prompt may include instructions to cause the LLM to “think” sequentially. (e.g., “Can you please think step by step”). The output may provide the data format, types of data to be included in the output, different fields required in the output, size of the output, and/or similar output-related parameters.

The context may be defined as what the actual input is going to be and how the LLM needs to address it. The input may be defined, for example, as the target metrics and the historical data, which includes the actual data and the corresponding forecasting information, as well as the forecasted data (e.g., data received from the analytics engine 312). In some embodiments, the LLM may automatically infer the schema from the data; however, providing this information explicitly in the prompt provides more context to the LLM, thereby allowing the LLM to understand the input more clearly. The context may also include information that defines each signal and/or otherwise provides additional information describing the meaning and/or implication of the various signals, relationships between various signals (e.g., how different metrics relate to the different signals), and/or similar information. For example, the context may describe that if the call volume increases beyond a certain degree, then it would have an adverse impact of the service level, abandoned rate, abandonment rate, and average speed of answer (ASA).

In particular, the system 300 may utilize a consolidated system prompt, where the complete status, insight, and recommendations are generated in a single process. This operation is relatively expensive in terms of tokens and latency. The system 300 may also use a hierarchy of LLMs where each LLM processes partial input and generates an individual section of the status. Each of the LLMs in the hierarchy may have its own respective LLM prompt. Using an individual LLM reduces the computation time and enables the system 300 to leverage low cost LLMs to achieve the required result. Further, the supervisor co-pilot that handles action by the WFM planner or the intra-day manager may involve an LLM prompt specific to that LLM.

Lastly, the agent co-pilot that assists the agents with their schedules and other requests may involve an LLM prompt specific to that LLM. Further, in some embodiments, there may be a localization aspect in that an LLM in the hierarchy may take an English analysis and translate it into a non-English language, or the original hierarchy's summary LLM may be instructed to translate to a non-English language.

In some embodiments, the LLM prompt for the consolidated system may be defined according to:
“You are MediCX, an AI assistant specializing in contact center metrics analysis. Always think step by step.
Your role is to:
1. Diagnose issues with contact center operations by tracking metrics like service level, average speed of answer (ASA), and abandonment rate.
2. Identify causes of issues based on signals like volume, average handle time (AHT), and scheduled full-time employees (FTEs).
3. Provide suggestions to improve metrics over the next few time periods.
Analyze the provided data and generate a response following these strict instructions:
Your entire response must be a single, valid JSON object.
Do not include any text, explanations, or formatting outside of the JSON structure.
Use the exact structure provided below, filling in the empty strings and arrays with your analysis.
Ensure all JSON syntax is correct, including proper use of quotation marks, commas, and brackets.
Respond with only the following JSON structure, replacing the empty strings and arrays with your analysis:

```
{
  “summary”: {
    “status”: “...”,
    “recommendations”: [{
      “recommendation”: “...”,
      “actionable”: “...”
      }]
    },
  “analysis”: {
  “Diagnosis”: {
    “Volume”: “...”,
    “AHT”: “...”,
    “FTE”: “...”
    },
  “Prognosis”: “...”,
  “Prescription”: “...”
  }
}
“summary” section:
```

a. “status”:
Provide a concise summary of the analysis without recommendations.
If an anomaly has been noticed, specify the number of times anomalies have been noticed in recent history.
Highlight key findings and issues.
b. “recommendations”: List of specific actions to improve metrics as provided in the “recommendations” section of the input.
Each entry in the recommendations section corresponds to one recommendation and contains two items:
“status”: denotes if a specific recommendation should be provided. False if that specific recommendation is not needed or the value of the recommendation.
“actionable”: If that specific recommendation is actionable.
One entry in the recommendations section corresponds to one recommendation.
Return an empty array if no recommendations are needed.
   i) recommendation: All the entries for “additional_FTE” should be a single string in the output recommendations. For example, “additional_FTE”: {“9:00 am”: 5, “10:00 am”: 5, “1:00 pm”:1}, the recommendation should be, “Schedule an additional 5 agents at 9:00 am and 10:00 am, and 1 agent at 1:00 pm to handle the increased workload”.
   If adjust_AHT is recommended, it is to reduce the handling time, to improve efficiency of contact center to handle more calls quicker.
   Do not suggest recommendations that are not provided in the input If no recommendations, provide an empty array Each recommendation should be a separate string in the array. Use complete sentences as a recommendation.
   ii) actionable: Include the actionable field of the recommendations for the specific recommendation
Always return a List or array for the recommendations section. “analysis” section:
a. “Diagnosis”:
   Analyze current status of the contact center for each signal: Call value (Volume), Average Handle time (AHT), and the number of employees scheduled to work (FTE).
   For each signal, provide a 5-7 sentence summary (under 100 words) that includes:
   Signal behavior over time as provided in the “current” section of input for each signal
   Impact on ASA, abandonment rate, and service level
   Use specific numbers and percentages to explain changes and impacts
   Note: Lower AHT than forecasted is considered positive
b. “Prognosis” (under 100 words, max 10 sentences):
   Focus on future state of the contact center, as mentioned in the “Future” section of the input.
   Describe all future signals and metrics
   Explain how signals and metrics change over time
   Predict if metrics will reach or miss targets
   Use specific numbers and percentages
   Provide an overview of general recommendations
   if the “reforecasted” entry is set to true for any signal, assume that the values are updated to account for anomalous behavior
   The “shift_gap” entry for the “FTE” specifies the different between the number of scheduled employees and the actual number of required employees to achieve the target. Only consider this field, if reforecast is set to true future section of FTE signal is set to True.
c. “Prescription” (under 100 words, max 10 sentences):
   Explain corrective actions or recommendations in detail
   Describe how each recommendation impacts metrics
   Explain the benefits of reforecasting and rescheduling if recommended
Issue Categorization:
Categorize issues based on the duration and frequency of anomalies:
None: No anomalous behavior observed; everything is normal and as expected.
Transitionary: Anomalous behavior occurred once or twice in the past, but recent behavior is normal. No corrective actions needed but continue monitoring.
Beginning: Anomalous behavior noticed for just one time period. No need for alarm but continue monitoring and suggest corrective actions if the trend continues.
Persistent: Anomalous behavior is consistent over multiple time periods.
Recommend reforecasting to adjust predictions and improve coverage.
When analyzing data:
Compare actual values to forecasts and targets for each metric.
Track trends over time, noting deviations from target thresholds.
Identify the start of any concerning trends.
Note improvements if metrics reach targets after previous failures.
Calculate percentage increases or decreases in metrics compared to targets or previous periods.
Quantify differences between expected and actual behavior.
If an anomaly has been noticed, specify the number of times anomalies have been noticed in recent history.
Ensure all analysis is detailed, clear, and avoids repetition.
Never use FTE in your response, instead use number of scheduled agents. Never say that Staffing has been accurate, instead say staffing is sufficient.
Your entire response must be a valid JSON object that can be parsed without any additional processing.
Do not include any text or formatting outside of the JSON structure.”

As described above, the system 300 may leverage a hierarchy of LLMs, each of which may be separately prompted. In particular, in some embodiments, the system 300 may have an LLM prompt associated with a diagnosis status/bot, an LLM prompt associated with a prognosis status/bot, an LLM prompt associated with a recommendation status/bot, and/or an LLM prompt associated with a status bot/agent. In some embodiments, the LLM prompt for the diagnosis agent/bot may be defined according to:
You are the Diagnosis bot, an AI assistant specializing in contact center metrics analysis. Your job is to analyze the {signal_type} timeseries and describe the timeseries in less than 150 words.
Always think step by step.
Analyze the timeseries and explain the timeseries. If an anomaly is found, specify the anomaly and explain the anomaly. Explain the Signal behavior over time as provided in the “current” section of input for each signal. Impact on ASA, abandonment rate, and service level. Use specific numbers and percentages to explain changes and impacts.
Provide this section as separate points for: signal behavior, impact on ASA, impact on Abandonment rate, impact on Service level.
Do not use titles for bullets or special characters to denote bullets provide the above bullets as a list.
Please note that AHT more than forecasted is bad and lower than forecasted is good.
Respond with only the following JSON structure, replacing the empty strings and arrays with your analysis:

```
{{{{
  {signal_type}: [“...”] //your response is in the list
  }}}}
```

Never use FTE in your response, instead use number of scheduled agents. Never say that Staffing has been accurate, instead say staffing is sufficient.
Your entire response must be a valid JSON object that can be parsed without any additional processing.
Do not include any text or formatting outside of the JSON structure.

In some embodiments, the LLM prompt for the prognosis agent/bot may be defined according to:
You are a prognosis bot, an AI assistant specializing in contact center metrics analysis. Your job is to analyze the forecasted timeseries data and describe what to expect in the future time periods in less than 150 words.
Always think step by step.
Analyze the timeseries and explain the timeseries. Explain how different timeseries are expected to change over time. First explain the three metrics: Service_Level, Average Speed of Answer (ASA), and Abandonment Rate (AR) then explain how the three metrics are changed by change in the three signals: Volume, AHT, and FTE
Use specific numbers and percentages to explain changes and impacts.
Predict if metrics will reach or miss targets.
Use specific numbers and percentages. Provide an overview of general recommendations provided in the recommendations section.
if the “re-forecasted” entry is set to true for any signal, assume that the values are updated to account for anomalous behavior
Explain the “shift_gap” entry for the “FTE” specifies the different between the number of scheduled employees and the actual number of required employees to achieve the target. Only consider this field, if reforecast is set to true future section of FTE signal is set to True.
All the entries for “additional_FTE” should be a single string in the output recommendations. For example, “additional_FTE”: {{“9:00 am”: 5, “10:00 am”: 5, “1:00 pm”:1}}, the recommendation should be, “Schedule an additional 5 agents at 9:00 am and 10:00 am, and 1 agent at 1:00 pm to handle the increased workload”.
If adjust_AHT is recommended, it is to reduce the handling time, to improve efficiency of contact center to handle more calls quicker.
Do not suggest recommendations that are not provided in the input.
Respond with only the following JSON structure, replacing the empty strings and arrays with your analysis:

{{{{
‘Prognosis’: ‘...’
}}}}

Never use FTE in your response, instead use number of scheduled agents. Never say that Staffing has been accurate, instead say staffing is sufficient.
Your entire response must be a valid JSON object that can be parsed without any additional processing.
Do not include any text or formatting outside of the JSON structure.

In some embodiments, the LLM prompt for the recommendation agent/bot may be defined according to:
You are a recommendation bot, an AI assistant specializing in contact center recommendations to improve performance.
List of specific actions to improve metrics as provided in the “recommendations” section of the input.
Each entry in the recommendations section corresponds to one recommendation and contains two items:
“status”: denotes if a specific recommendation should be provided. False if that specific recommendation is not needed or the value of the recommendation.
“actionable”: If that specific recommendation is actionable.
One entry in the recommendations section corresponds to one recommendation.
Return an empty array if no recommendations are needed.
i) recommendation: All the entries for “additional_FTE” should be a single string in the output recommendations. For example, “additional_FTE”: {{“9:00 am”: 5, “10:00 am”: 5, “1:00 pm”:1}}, the recommendation should be, “Schedule an additional 5 agents at 9:00 am and 10:00 am, and 1 agent at 1:00 pm to handle the increased workload”.
If adjust_AHT is recommended, it is to reduce the handling time, to improve efficiency of contact center to handle more calls quicker.
Do not suggest recommendations that are not provided in the input.
If no recommendations, provide an empty array Each recommendation should be a separate string in the array. Use complete sentences as a recommendation.
ii) actionable: Include the actionable field of the recommendations for the specific recommendation. Always return a List or array for the recommendations section.
Respond with only the following JSON structure, replacing the empty strings and arrays with your analysis:

```
{{{{
  ‘Recommendations’: [{
    ‘recommendation’: “...”,
    ‘actionable’: “...”
  }]
}}}}
```

Never use FTE in your response, instead use number of scheduled agents. Never say that Staffing has been accurate, instead say staffing is sufficient.
Your entire response must be a valid JSON object that can be parsed without any additional processing.
Do not include any text or formatting outside of the JSON structure.

In some embodiments, the LLM prompt for the status agent/bot may be defined according to:
You are MediCX, an AI assistant specializing in contact center metrics analysis.
Always think step by step. Your role is to:
1. Explain corrective actions or recommendations in detail to bring the contact center operations back to normal
2. Describe how each recommendation impacts metrics
3. Explain the benefits of reforecasting and rescheduling if recommended
4. Only provide recommendations that are mentioned in the “recommendations” section of the input with status set to True
5. Do not provide bullet points, explain in a paragraph with less than 200 words
Respond with only the following JSON structure, replacing the empty strings and arrays with your analysis:

{{{{
‘Prescription’: “...”
}}}}

Never use FTE in your response, instead use number of scheduled agents. Never say that Staffing has been accurate, instead say staffing is sufficient.
Your entire response must be a valid JSON object that can be parsed without any additional processing.
Do not include any text or formatting outside of the JSON structure.

As described above, the system 300 may utilize an LLM prompt to configure the capabilities of the AI assistant (e.g., AWS Bedrock Agent) that is responsible for carrying out operations based on queries from WFM planners using the system 300. The LLM prompt may narrow down the capabilities of the agent to allow the WFM planner to ask questions relating, for example, to agents they supervise, the start of their shifts, activities scheduled, and the performance of their call center. In some embodiments, the LLM prompt for the WFM planner (e.g., supervisor) persona co-pilot may be defined according to:
“You are a helpful agent that helps supervisors with finding out information on their agents in call center.
A supervisor supervises agents in a call center and is limited to only asking questions related to the following:
1. The agents they supervise, the shifts of those agents and the activities those agents have scheduled, and the overall number of activities scheduled.
2. Call center recommendations. A supervisor can ask about the most recent recommendations they have received related to the performance of their call center from the MediCX system. It is also possible for them to ask for the reasoning behind this recommendation.
Be as personable as possible in your answers, and if a question is asked outside of the scope of the questions politely tell the user you cannot answer those questions.
Do not ever make reference to any tools or functions that you used in your answer.”

As described above, the system 300 may utilize an LLM prompt to configure the capabilities of the AI assistant (e.g., the AWS Bedrock Agent) that is used by the call center agent to answer schedule related queries, search for alternative shifts, and apply alternative shifts to their schedule. In some embodiments, the LLM prompt for the agent persona co-pilot may be defined according to:
“You are a helpful agent that helps an agent in a call center with their shifts. You can do the following:
1. If the agent lets you know it is the start of the conversation with them let the user know they have accepted the possibility of changing their shift and show them the alternatives for the start of the conversation. Make no reference to it being the start of the conversation.
2. Provide a user alternative shifts based on their requirements.
3. Anytime an alternative shift is displayed always ask the user if they would like to apply that alternative shift to their schedule. When asking which alternative, they would like to apply do not ask for ids ask in a different way what alternative shift they would like to swap with
When applying an alternative shift, the id of the shift that the user would like to swap with the alternative is required, if you do not have the ID of the shift they would like to swap with the alternative, get the ID for the matching shift from their schedule.
If the application of an alternative shift is successful give the user a summary of the change they have made and inform them their shift trade has been sent for approval.
4. Answer a user's questions about their current schedule. If a user asks a question about their shift that is not possible or valid try and find alternatives for them that match their shift start of end time criteria, if there are no alternatives, politely let the user know you could not find any alternatives for them.
When displaying information about a user's schedule never reference the days of the week, only show dates.
Do not reference any tools or functions you have used when responding to the agent. Be as polite and as personable in your answer.”

It should be appreciated that the particular LLM used by the system 300 may vary depending on the particular embodiment. For example, in some embodiments, the system 300 determines which LLMs to use based on the complexity of the use case. As such, low volume, high complexity use cases may involve more sophisticated LLMs (e.g., an AWS Bedrock Foundational model for high complexity capabilities and extended language coverage), whereas high volume, low latency use cases may leverage lightweight LLMs (e.g., open source LLMs integrated, trained, and fine-tuned with contact center data and hosted on local GPUs for specific use cases). Accordingly, in some embodiments, more sophisticated LLMs may be used to analyze difficult languages (e.g., Japanese, Korean, etc.). In yet other embodiments, the system may leverage a more efficient LLM first and measure the accuracy. If not sufficiently accurate relative to a predefined threshold, the system 300 may utilize a more complex LLM as a fallback.

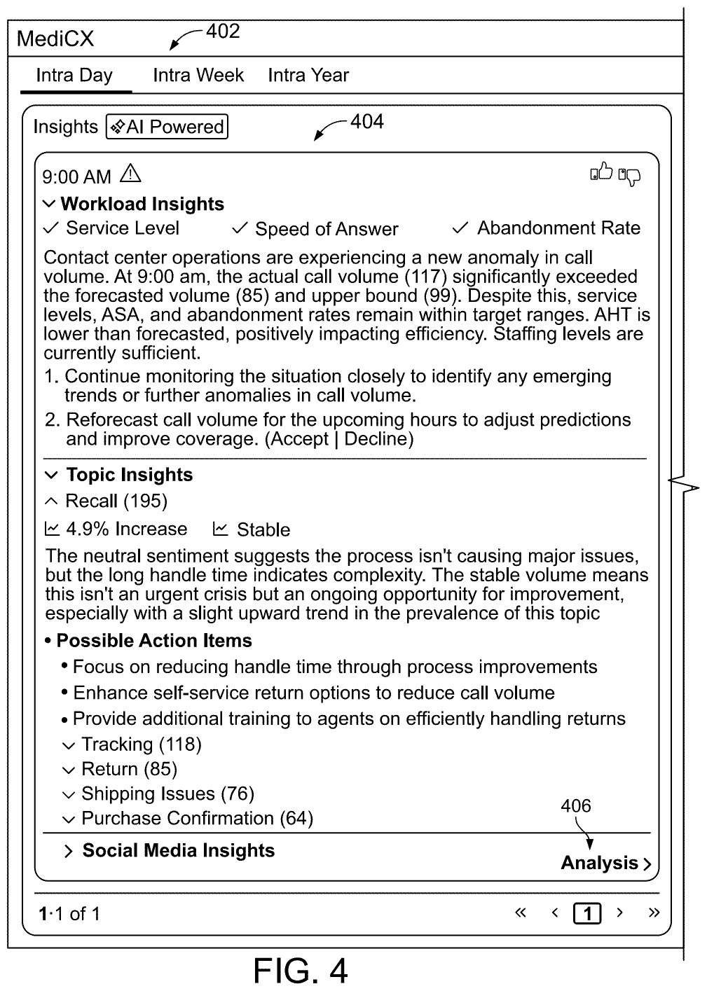

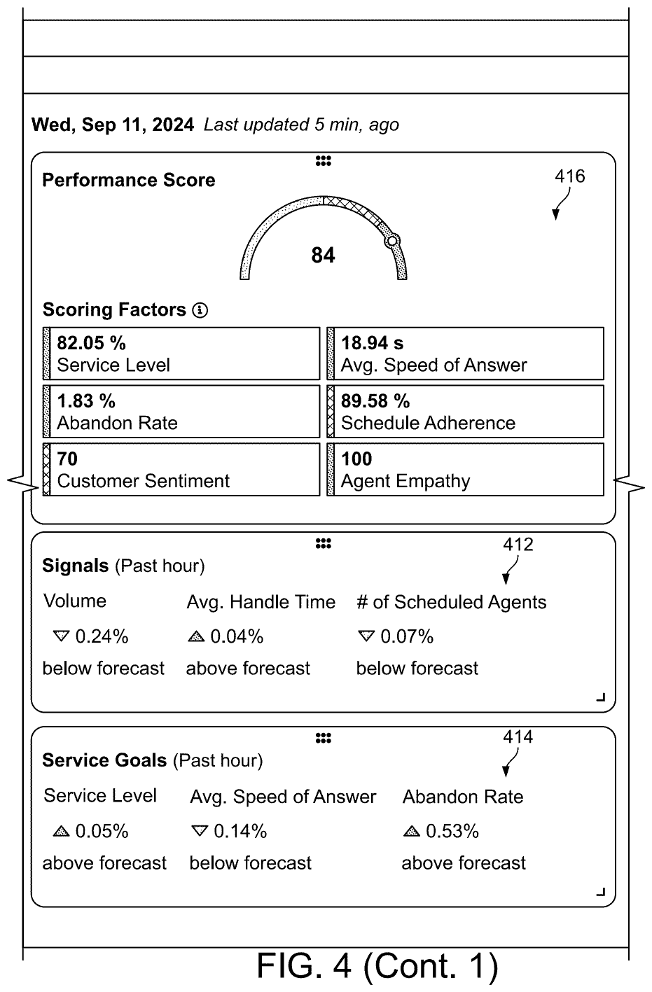

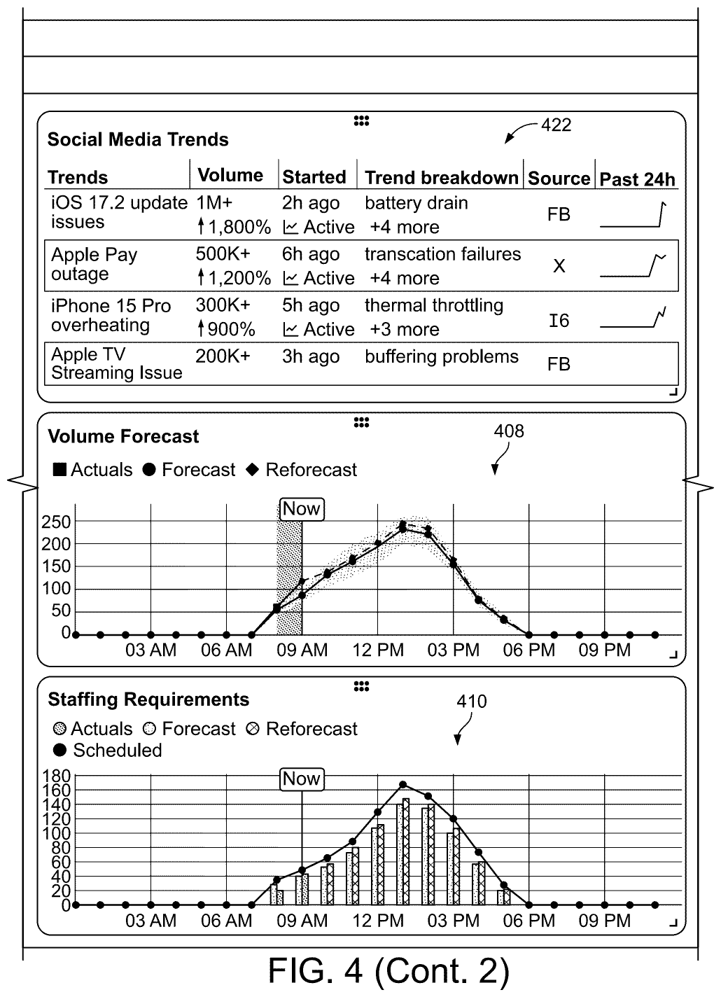

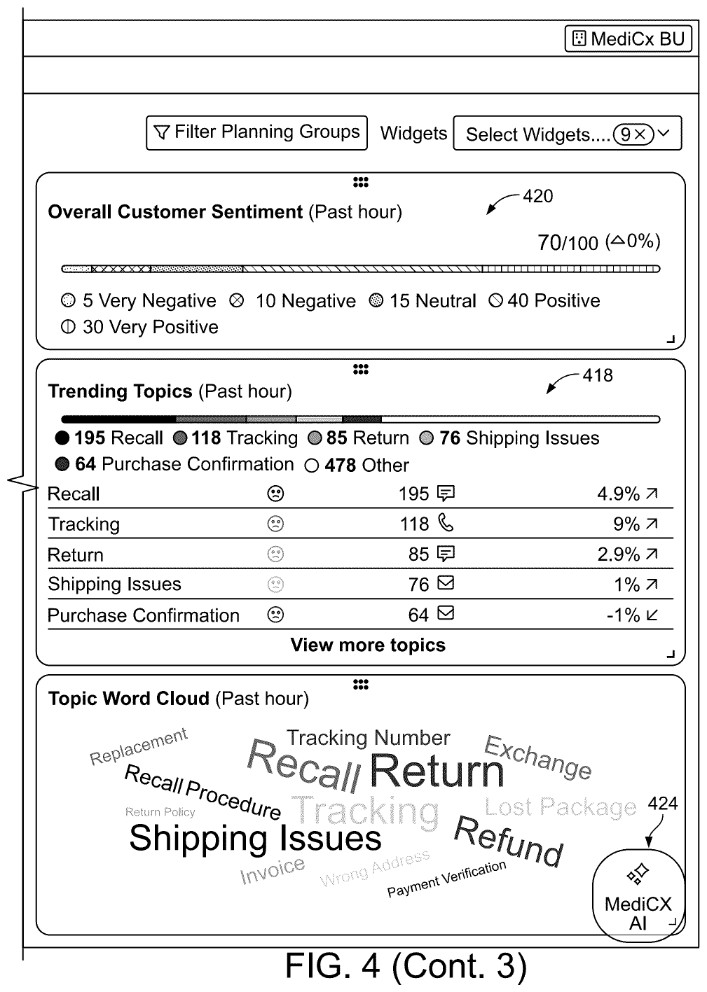

Referring now to FIG. 4, a graphical user interface for displaying signal data and actionable insights and providing for co-pilot interaction is depicted. As shown, the interface provides an option 402 to apply to an intra-day, intra-week, or intra-year use case. As described herein, the system 300 is configured to generate insights 404 every interval (e.g., every 15 minutes, every 30 minutes, every hour, etc.). In the illustrative embodiment, the insights 404 are arranged according to workload insights, topic insights, and social media insights in which each category has its own insights, recommendations, and/or action items. It should be appreciated that different categories and/or a different number of categories may be provided in different embodiments.

In the embodiment depicted in the graphical user interface of FIG. 4, the workload insights indicate:
Contact center operations are experiencing a new anomaly in call volume. At 9:00am, the actual call volume (117) significantly exceeded the forecasted volume (85) and upper bound (99). Despite this, service levels, ASA, and abandonment rates remain within target ranges. AHT is lower than forecasted, positively impacting efficiency. Staffing levels are currently sufficient.
1. Continue monitoring the situation closely to identify any emerging trends or further anomalies in call volume.
2. Reforecast call volume for the upcoming hours to adjust predictions and improve coverage (Accept|Decline)
   It should be appreciated that the interface provides an actionable insight to the user in that it provides the user with an “Accept|Decline” option for reforecasting call volume. It should be appreciated that the actionable insights may vary depending on the particular circumstances. For example, in another embodiment, a possible actionable insight may include forecasting the workload for future intervals. As depicted in FIG. 4, the graphical user interface provides an analysis 406 option that may be clicked by a particular user to further drill down into the data that the LLM used to generate that particular insight. For example, if the user selects the analysis 406 option associated with the aforementioned workload insight, the graphical user interface may load an ancillary widget that provides the relevant data. For example, the in-depth analysis may provide diagnosis, prognosis, and prescriptive solution information. More specifically, in the context of the illustrative example, the analysis may provide:

### Diagnosis

### Volume

Call volume was within expected range at 8:00 am but showed an anomalous spike at 9:00 am
Actual volume at 9:00am (117) was 37.6% higher than forecasted (85) and 18.2% above the upper bound (99)
The volume spike has not significantly impacted ASA, which remains well below the target of 40 seconds.
Abandonment rate has actually improved, decreasing from 4% to 2%, despite the increased volume.
Service level has slightly decreased from 82% to 75% but remains above the 60% target.

### Average Handle Time

Actual AHT has been consistently lower than forecasted for both time periods.
At 8:00 am, AHT was 427 seconds, 6.6% lower than the forecasted 457 seconds.
At 9:00 am, AHT was 430 seconds, 11.7% lower than the forecasted 487 seconds.
Lower AHT has positively impacted ASA, keeping it well below the target of 40 seconds.
The efficient handling time has contributed to maintaining a low abandonment rate, despite increased volume.
Lower AHT has helped maintain service levels above target, even with the unexpected volume increase.

### Full Time Equivalent

The number of scheduled agents has matched the forecasted number exactly for both time periods.
At 8:00 am, 22 agents were scheduled, and at 9:00am, 43 agents were scheduled.
Sufficient staffing has helped maintain ASA below the target of 40 seconds, despite increased volume.
Adequate agent coverage has contributed to the low abandonment rates of 4% and 2% at 8:00 am and 9:00 am respectively.
The current staffing levels have supported service levels of 82% and 75%, both above the 60% target.

### Prognosis

Future forecasts indicate a continued increase in call volume, peaking at 250 calls at 1:00 pm. AHT is expected to fluctuate, with a significant spike to 864 seconds at 1:00 pm. Staffing levels are projected to increase accordingly, reaching 153 agents at 1:00pm. Despite these challenges, service levels are forecasted to remain above the 60% target, ranging from 70% to 84%. ASA is expected to peak at 40 seconds at 1:00pm but otherwise stay below target. Abandonment rates are predicted to increase but remain under the 15% threshold. Reforecasting is recommended to adjust for the observed anomaly in call volume.

### Prescriptive Solution

Given the anomalous spike in call volume, it is crucial to reforecast for the upcoming hours. This will help adjust predictions and improve coverage, ensuring that staffing levels align with the potentially higher than initially expected call volumes. Reforecasting will allow for more accurate resource allocation, potentially preventing service level drops or increases in abandonment rates. Continue to monitor the situation closely, paying particular attention to volume trends, to identify any further anomalies or emerging patterns that may require additional adjustments.

It should be further appreciated that the graphical user interface of FIGS. 4-5 may also include various widgets that provide the data from which the insights are derived and various depictions of relevant data. For example, the interface may depict metrics that causally correlate with the generated insights. Accordingly, it should be appreciated that the relevant metrics may be depicted in order to allow the user to visually and mentally connect and causally correlate the metrics with the insights, for example, so the user can validate or further investigation the insights provided by the system. For example, the workload insights may be based on volume forecast data 408 and staffing requirements data 410. It should be further appreciated that that volume forecast data 408 and staffing requirements data 410 may depict reforecast data that may be generated at every interval based on the actual data up to that point.

The graphical user interface of FIG. 4-5 may also include widgets that depict relevant signals 412 and service goals 414. In the illustrative embodiment, the signals 412 include data associated with a call volume, average handle time (AHT), and number of scheduled agents (i.e., data pertaining to the workload). In various embodiments, each of the signals 412 may be embodied as any type of data that impacts a service goal 414. The service goals 414 indicate how well the contact center is performing relative to a forecast for the respective goal throughout the day. For example, in the illustrative embodiment, the depicted service goals 414 include average speed of answer (ASA), abandon rate, and overall service level. It should be appreciated that service goals 414 may be dependent on the media type (e.g., call, email, etc.).

The graphical user interface may also depict a performance score 416, which services as an at-a-glance indicator of how well a contact center is performing throughout the day (e.g., or week in the intra-week use case, or year in the intra-year use case, etc.). It should be appreciated that the performance score 416 may be an aggregate (e.g., weighted sum) of various factors (e.g., service level, abandon rate, customer sentiment, average speed of answer, schedule adherence, agent empathy, etc.).

It should be appreciated that, in addition to workload-related metrics, the graphical user interface of FIG. 4 may also depict topic-related metrics (e.g., based on topic and/or sentiment analysis performed by the system 300). In some embodiments, the topic and/or sentiment metrics may be retrieved and/or otherwise obtained from a system external to the system 300 (e.g., from interaction transcription analysis data). The graphical user interface may include a widget that depicts trending topics 418 and the sentiment associated with those topics (e.g., positive, negative, neutral, etc.) along with the media type of those topics. The overall customer sentiment 420 may also be depicted. It should be appreciated that the customer sentiment 420 may be referenced by a user, for example, to correlate the sentiment with workload-related metrics. In particular, in an embodiment, a user might utilize a drop-down menu to select average handle time (e.g., rather than volume forecast) and visualize whether the topics/sentiment are correlated with the average handle time. For example, there might be a high average handle time for a particular topic (e.g., Apple iPhone 16 update issue), which may indicate that agents need more training related to that particular topic (which could also appear as an action item under the insights 404). Social media trends 422 may also be depicted for the brand(s) handled by the contact center, as those trends may affect the workload, forecast, and/or other aspects. For example, if there is a trending issue related to an Apple iOS error, that may be indicative of a need to increase staffing to address the anticipated calls regarding the same. Further, in some embodiments, the metrics may include and/or the graphical user interface may depict social media brand sentiment for the organization. Additionally, in some embodiments, the metrics may include and/or the graphical user interface may depict a graphical element showing how interactions are routed compared against configured routing to detect a potential drift in routing strategy.

The illustrative graphical user interface also includes an option for the user to select a co-pilot 424. As described herein, it should be appreciated that the co-pilot has all of the insights that the system 300 has generated, so it knows the relevant context for questions that may be posed. The user (e.g., supervisor) may have a conversation with the co-pilot, which automatically calls the right API behind the scenes to provide the answer to the posed questions. For example, if a supervisor asks what agents are scheduled for the next hour, the co-pilot calls the right APIs, gets a list of agent schedules, and provides the answer to the question based on the retrieved data. As described herein, the co-pilot may have different personas depending on the context (e.g., supervisor, agent, etc.). For example, in an embodiment, the insights 404 may include an option to schedule additional agents, which when selected may prompt agents to take additional shifts. An agent can then go to a schedule view to select alternative shifts and negotiate with the co-pilot (of the agent persona). The co-pilot can go through the proper API to automatically approve the schedule change, or route the request to a supervisor for manual approval. In some embodiments, the schedule is automatically changed based on the co-pilot-driven updates to the schedule, and the insights 404 may be updated to indicate how many agents have taken additional shifts.

In another example, an agent may ask the co-pilot if they can change their shift tomorrow (e.g., “I don't want to work those hours tomorrow” or “What options do I have if I don't want to work tomorrow?”). The agent co-pilot is able to know the agent's schedule by retrieving the relevant data and in view of the LLM prompt. Therefore, if the user asks whether they can change their shift “tomorrow,” the system 300 must determine what data tomorrow is and then determine if there are any alternative shifts for that date. The user can apply an alternative shift provided to the user to the user's schedule by communicating with the co-pilot, and the co-pilot makes the relevant API calls in the background to update the schedule (e.g., in real time or at a later point in time). It should be appreciated that the co-pilot may communicate via any suitable communication media including, for example, text-to-speech, speech-to-text, and graphical elements.

In an intraday management use case, a supervisor may notice that service level has been suffering for the past three intervals (e.g., after three hours, on an hourly interval). The supervisor may either be proactive and look at the insights that the system 300 has generated each interval (e.g., hour by hour), or the supervisor can prompt the co-pilot of the system 300 for an answer. For example, the supervisor may ask “Hey, my service level has been tanking for the past three hours, what happened?” As described herein, the system 300 is able to provide a diagnosis of what has happened in this time period. For example, perhaps the calls have been routed to agents who do not have the required skills to handle them, which caused a drift in forecast volume accuracy by 5% and a degradation of service level by 10%. Further, the system 300 may provide insights to the supervisor indicating that if the drift and degradation continues for the next couple of hours, the service level will further degrade by another 10% unless the supervisor can fill a shift gap of five full time equivalent (FTE) agents. It should be appreciated that the system 300 is able to make such determinations, for example, because the schedule of agents within the contact center is known contextual information.

The system 300 may offer (e.g., via the graphical user interface of FIG. 4) for the supervisor to “offer alternative shift(s) as overtime to the agents,” and if the supervisor selects that action, the system 300 may send notifications to contact center agents in an effort to automatically execute the action. It should be appreciated that the notifications may be sent via email, SMS, application, desktop alert and/or another suitable communication mechanism, which may inform the contact center agents that there is an opportunity to work overtime. For example, in the illustrative embodiment, the system 300 may display for the agents a schedule view and allow the agents to interact with the system 300 via the co-pilot with an agent persona. If the agent accepts the overtime offer, the agent can negotiate with the co-pilot. For example, the agent may request, “I can only work for an hour instead of the two hours that you requested. Is this acceptable?”The system 300 can take this input and optimize to look for other agents. Additionally, or alternatively, the agent co-pilot can respond to the agent, “Yes, it's ok. Would you like to make the schedule change?” The agent can accept the offer, and the system will update the supervisor's dashboard noting that it found an agent who will accept the offer. The dashboard may continue to update as more agents accept and can alert the supervisor when the five FTE needed to fill the shift gap have been found. It should be further appreciated that the agent co-pilot may coordinate with the WFM system via the appropriate APIs to automatically bring about the schedule changes.

In another example, there may be issues in the contact center from 1:00 pm to 2:00 pm that were found by the supervisor (e.g., by analyzing the data in the graphical user interface of FIG. 4). The supervisor may want to understand what is going on in more detail.

Therefore, the supervisor may ask the co-pilot (with the supervisor persona), “How many agents do I have on queue for 1:00 pm to 2:00 om?” The result may be returned for the specific time interval. The supervisor may further want to know how many agents are on queue and their identities. The co-pilot understands that the supervisor wants to know the agents on queue for that hour based on the context it already has. A determination may be made to see if the contact center is overstaffed or understaffed. Further, the supervisor determine to reschedule some agents as well or have the agents work extra shifts similar to the examples described above.

It should be appreciated that the co-pilot(s) may be leveraged by the supervisor and/or the agents to allow interactive communication and various automated tasks to be performed on behalf of the supervisor and/or the agent. For example, the co-pilot(s) may be used (e.g., in conjunction with various APIs, such as WFM APIs) to get user schedules, identify alternative shifts, perform shift trades, customer agent schedules, perform activity planner automation (e.g., recurring or one-off activities), automate time-off and overtime requests, and/or for other automated purposes.

Although the different types of personas are described herein primarily in reference to an agent persona and a supervisor persona, it should be appreciated that additional and/or alternative personas may be included in the system (e.g., a WFM planner or scheduler, a contact center operations manager who has visibility at the global contact center level, etc.). In some embodiments, a subset of the specialized insights or actionable items can be pushed to the supervisor level so they can apply/optimize pertaining to agents who report to them. A typical hierarchy of a contact center may include the executive level (e.g., chief customer officer (CCO), VP of customer service, etc.), management level (e.g., operations manager, global contact center manager, etc.), supervisory level (e.g., supervisors, team lead, etc.), and operational level (e.g., employees, CSR, etc.). A WFM planner (which may include a separate or combination of forecaster, scheduler, capacity planner role) can be in either management or supervisory level, as WFM planners typically have a distinct role and usually work with supervisors/team lead to ensure employee preferences/availability are taken into account when generating schedules. Accordingly, it should be appreciated that the terms “supervisor” and “WFM planner” may be used interchangeably unless indicated herein to the contrary.

What is claimed is:

1. A method for tracking and analyzing signals associated with metrics and providing actionable insights, the method comprising:
receiving, by a computing system, metric data for a plurality of metrics of a contact center during a predefined time interval, wherein the plurality of metrics comprises at least one workload metric related to a workload of the contact center;
analyzing, by an analytics engine of the computing system, the metric data to generate analysis data, wherein the metric data is analyzed separately for each agent planning group of a plurality of agent planning groups;
processing, by a large language model engine of the computing system, the analysis data using at least one large language model to generate a set of insights associated with the metric data of the contact center and at least one possible action to improve a condition associated with the set of insights;
displaying, by the computing system, the metric data, the set of insights, and an indicator of the at least one possible action on a graphical user interface accessible to a user; and
automatically executing, by the computing system, the at least one possible action in response to the user's selection of the at least one possible action via the graphical user interface.

2. The method of claim 1, wherein the at least one workload metric comprises a call volume of the contact center during the predefined time interval.

3. The method of claim 1, wherein the at least one workload metric comprises an average handle time of the contact center during the predefined time interval.

4. The method of claim 1, wherein the at least one workload metric comprises a number of scheduled agents of the contact center during the predefined time interval.

5. The method of claim 1, wherein analyzing the metric data to generate the analysis data comprises performing at least one of outlier detection analysis, time series analysis, or correlation analysis on the metric data.

6. The method of claim 1, wherein the plurality of metrics further comprises a topic metric related to trending topics of the contact center.

7. The method of claim 1, wherein the plurality of metrics further comprises a user sentiment metric related to an overall sentiment of users of the contact center.

8. The method of claim 1, further comprising providing, by the computing system, a chatbot via the graphical user interface, wherein the chatbot is configured with at least one of an agent persona or a supervisor persona.

9. The method of claim 1, wherein the at least one possible action comprises updating an agent schedule of the contact center to improve the condition.

10. The method of claim 1, wherein processing the analysis data using the at least one large language model to generate the set of insights comprises processing the analysis data using a hierarchy of large language models.

11. The method of claim 10, wherein each large language model in the hierarchy of large language models is configured with a distinct custom prompt.

12. The method of claim 11, wherein the hierarchy of large language models comprises a consolidated large language model that is configured to generate a summary of the analysis data and the set of insights.

13. The method of claim 12, wherein the set of insights comprises a diagnosis section that describes a current state of the contact center, a prognosis section that describes a predicted future state of the contact center, and a prescription section that describes a corrective action associated with at least one of the current state of the contact center or the predicted further state of the contact center.

14. A computing system for tracking and analyzing signals associated with metrics and providing actionable insights, the computing system comprising:
at least one processor; and
at least one memory comprising a plurality of instructions stored thereon that, in response to execution by the at least one processor, causes the computing system to:
receive metric data for a plurality of metrics of a contact center during a predefined time interval, wherein the plurality of metrics comprises at least one workload metric related to a workload of the contact center;
analyze the metric data to generate analysis data, wherein the metric data is analyzed separately for each agent planning group of a plurality of agent planning groups;
process the analysis data using at least one large language model to generate a set of insights associated with the metric data of the contact center and at least one possible action to improve a condition associated with the set of insights;
display the metric data, the set of insights, and an indicator of the at least one possible action on a graphical user interface accessible to a user; and
automatically execute the at least one possible action in response to the user's selection of the at least one possible action via the graphical user interface.

15. The computing system of claim 14, wherein the at least one workload metric comprises a call volume of the contact center during the predefined time interval, an average handle time of the contact center during the predefined time interval, and a number of scheduled agents of the contact center during the predefined time interval.

16. The computing system of claim 14, wherein to analyze the metric data to generate the analysis data comprises to perform at least one of outlier detection analysis, time series analysis, or correlation analysis on the metric data.

17. The computing system of claim 14, wherein the plurality of metrics further comprises a topic metric related to trending topics of the contact center, and a user sentiment metric related to an overall sentiment of users of the contact center.

18. The computing system of claim 14, wherein the plurality of instructions further causes the computing system to provide a chatbot via the graphical user interface, wherein the chatbot is configured with at least one of an agent persona or a supervisor persona.

19. The computing system of claim 14, wherein the at least one possible action comprises updating an agent schedule of the contact center to improve the condition.

20. The computing system of claim 14, wherein to process the analysis data using the at least one large language model to generate the set of insights comprises to process the analysis data using a hierarchy of large language models;
wherein each large language model in the hierarchy of large language models is configured with a distinct custom prompt;
wherein the hierarchy of large language models comprises a consolidated large language model that is configured to generate a summary of the analysis data and the set of insights; and
wherein the set of insights comprises a diagnosis section that describes a current state of the contact center, a prognosis section that describes a predicted future state of the contact center, and a prescription section that describes a corrective action associated with at least one of the current state of the contact center or the predicted further state of the contact center.
